(19) United States
(12) Patent Application Publication
(10) Pub. No.: US 2013/0290111 A1
(43) Pub. Date: Oct. 31, 2013

(54) SYSTEM AND METHOD FOR DELIVERY OF MARKETING FOR MULITPLE ENTITIES

(71) Applicant: Michael Frankel, NEW YORK, NY (US)

(72) Inventor: Michael Frankel, NEW YORK, NY (US)

(21) Appl. No.: 13/658,326

(22) Filed: Oct. 23, 2012

Related U.S. Application Data
(60) Provisional application No. 61/550,440, filed on Oct. 23, 2011.

(51) Int. Cl. G06Q 30/02

(52) U.S. Cl. CPC G06Q 30/0269
USPC 705/14.66

(57) ABSTRACT

A system for collecting and distributing advertisements to customers based on an event or attribute of the customers includes a client interface and a client database for storing advertising content. A processor receives distribution parameters from the client regarding the distribution of advertisement data to any one of a plurality of subscribers. A subscriber interface and a subscriber database are connected to the processor for storing profile data for each of the subscribers, the profile data including at least one dated attribute associated with the subscriber. For each of the client advertisement content stored in the client database, a corresponding distribution attribute is stored including at least in part a distribution date. The processor reviews a present date and compare against shared distribution dates and to distribute the advertisement content having the present date as a distribution date to one or more subscribers according to the distribution parameters.

### RELATED APPLICATION

This application claims the benefit of priority from U.S. Provisional Patent Application No. 61/550,440, filed on Oct. 23, 2011, the entirety of which is incorporated by reference.

### BACKGROUND

1. Field of the Invention

This application relates to a marketing system. More particular, the present application relates to a system and method for targeting/pushing advertising to selected subscribers.

2. Description of Related Art

In the prior art in the area of business to consumer advertising, many businesses have lists of customers that they email periodically. These emails include information, promotional sales, and loyalty clubs. Some companies email their existing list of customers gifts for their birthdays. For example, an ice cream company may collect the birthdays of its customers and email them certificates for a free scoop of ice cream on their birthdays. Companies sending these types of gifts via email to their customers typically refer to these birthday gifts as the company's birthday club. This relationship is limited to a one to one ratio, where one company sends a gift to its subscribers, and where a subscriber can opt-in and receive a gift from only one company.

Additionally, certain web based businesses exist for consumers to go to in order to see a list of companies that offer birthday clubs. Here, a user must go to each third party website (i.e. each company's website) and opt-in to the company's list.

Additionally, some companies pay third party companies to advertise the company's products or services. Third parties typically advertise many companies. Some of these third parties advertise companies through email marketing. These emails typically do not focus on a specific lifecycle event for the recipient or a specific attribute of the subscriber but rather on a specific theme of the company or of the third party.

### OBJECTS AND SUMMARY

The present arrangement provides for a marketing system and method that allows a third party to aggregate and promote a multitude of companies to customers and potential customers based on an event or attribute specific to the customer or potential customer. In marketing terminology, this method represents a push method where gifts/offers/sales/information are pushed to the customer or potential customer based on an event specific to the customer or potential customer. Thus, unlike the above options, the present arrangement not only has the ability to reach customers who have not directly contacted the advertising business, but it can target said advertisement to the potential customers based on specific attributes of those recipients (e.g. their birthday) based on them having opted into the present system.

For example, the present arrangement allows for marketing and electronic communications, where email, text messaging, instant messaging, social media, or a non-standard mail method is used as a vehicle to advertise, market, and communicate with costumers. The present invention has many variations with the common thread being that a specific attribute or specific life-cycle event of the recipient is used to present that recipient with gifts/offers/sales/coupons from national and/or local companies.

According to the present arrangement, subscribers can register with the system either online through a website or associated Facebook (social media) page, via email with the system, in person at events with a live system presence, or in person or online with one of the system's partners.

At registration, a potential customer is invited to register their birthday and email address, along with any other desired profile information that may be relevant to a potential advertiser, depending on the comfort level of the customer/subscriber. Upon registering, the subscriber receives a welcome email. When the subscriber's birthday month approaches, the subscriber may automatically receive one or more emails with birthday gifts from local and national companies. These emails are sent to the subscriber without any further action required by the subscriber. Once the subscriber accounts are created in the system, such advertisements may be automatically sent to the subscriber with a certain number of days before or after, or even on, the subscriber's birthday (or other event, wedding, graduation, anniversary, half birthday, etc. . . . ).

From the business or client side, the companies do not need to “pull” a subscriber onto their list before reaching them with birthday/event messaging nor, as outlined above, nor do subscribers have to actively seek out the company before, to receive its birthday perk. Instead, by registering once with the system the subscriber is able to receive gifts from multiple companies he or she may not have heard of, and the company is able to “push” its targeted message and birthday perk to a potential customer (or customers with shared attributes) whom the business may not have had a relationship with before.

Businesses/clients of the system may periodically choose which subscribers should receive a particular gift offer, if not all, by selecting various attributes of the intended recipients. The system then limits the recipients of the gift to only those matching the attributes selected so that firstly companies are not soliciting unwanted advertisements to possible customers and simultaneously knowing that the receivers have actively opted into the system, and are thus potentially desirable customers. These attributes may include events, birthdays, gender, zip code, age, or any other available attributes that have been offered to the system by the subscriber/customer, or collected by the system utilizing other methods of collecting data, such as employing websites that collect data based on email addresses and then appending files with the information collected.

Thus, according to the above described attributes, at least one of the present arrangement's distinguishing components over the prior art is a many-to-one-to-many relationship. The invention serves as a vehicle for many businesses/clients to reach many consumers/subscribers as well as for many subscribers/consumers to get gifts/sales/discounts/coupons from many businesses by opting-in to one (attribute/event) list. In other words, the arrangement provides a system for subscribers/customers to opt-in and receive gifts/offers/sales/coupons from multiple businesses all via one location.

A second distinguishing component of the present arrangement over the prior art, especially when combined with the previously described advantage, is the trigger that activates when the 3^{rd} party using the present system and method sends the gifts/coupons/sales/discounts to the recipient. This trigger is based on a specific attribute of the subscriber and/or a lifecycle event of the subscriber and/or some outside event/holiday celebrated by the subscriber.

When viewed together, the present arrangement provides a novel system and method of promoting, advertising, or marketing a multitude of companies to a customer or potential customer based on an attribute specific to the customer or potential customer or a life-cycle event for that customer or potential customer or a holiday or event that may be celebrated by that customer or potential customer.

Such a system and method (1) affords an opportunity to subscribe to a list to receive gifts/offers/coupons/sales from local and/or national companies based on information specific to the subscriber; (2) enlists local and/or national companies to present the subscriber with a gift/offer/coupon/sale that is presented to that subscriber because of an attribute specific to that subscriber or for a lifecycle event of that subscriber or an event/holiday celebrated by that subscriber; and (3) sends those gifts/offers/coupons/sales electronically, or not electronically, to that subscriber on a specific date or series of dates according to the attribute specific to that subscriber or the life-cycle event of that subscriber or holiday/event celebrated by that subscriber.

Thus a first object of the present arrangement is the increased likelihood of the advertiser acquiring the customer based on the gift/offer/coupon/sale presented to that subscriber.

Another object of the present arrangement is the incremental revenue generated by the advertiser from the redemption of the gift/offer/coupon/sale presented to that subscriber.

Another object of the present arrangement is the customer loyalty generated by the company because of the gift/offer/coupon/sale presented to that subscriber.

Another object of the present arrangement is the ease of use for the subscriber to receive gifts/offers/coupons/sales from a multitude of companies without having to subscribe to multiple lists.

Another object of the present arrangement is the ability to present the subscriber with gifts/offers/coupons/sales based on an attribute of that subscriber and/or some characteristic of that subscriber.

To this end the present arrangement provides a system for collecting and distributing advertisements to customers based on an event or attribute of the customers includes a client interface and a client database for storing advertising content. A processor receives distribution parameters from the client regarding the distribution of advertisement data to any one of a plurality of subscribers. A subscriber interface and a subscriber database are connected to the processor for storing profile data for each of the subscribers, the profile data including at least one dated attribute associated with the subscriber. For each of the client advertisement content stored in the client database, a corresponding distribution attribute is stored including at least in part a distribution date. The processor reviews a present date and compare against shared distribution dates and to distribute the advertisement content having the present date as a distribution date to one or more subscribers according to the distribution parameters.

### BRIEF DESCRIPTION OF DRAWINGS

The present invention can be best understood through the following description and accompanying drawings, wherein:

FIG. 1 is a system diagram showing the present system in relation to clients and subscribers, in accordance with one embodiment;

FIG. 2 is a system diagram showing an exemplary set of system components, in accordance with one embodiment;

FIG. 3 is a flow chart showing a subscriber interaction with the system, in accordance with one embodiment;

FIG. 4 is a table diagram of subscriber information, in accordance with one embodiment;

FIG. 5 is a flow chart showing a client interaction with the system, in accordance with one embodiment;

FIG. 6 is a table diagram of advertisement list option for clients, in accordance with one embodiment; and

FIG. 7 is a flow chart showing a client-subscriber-system interaction, in accordance with one embodiment.

### DETAILED DESCRIPTION

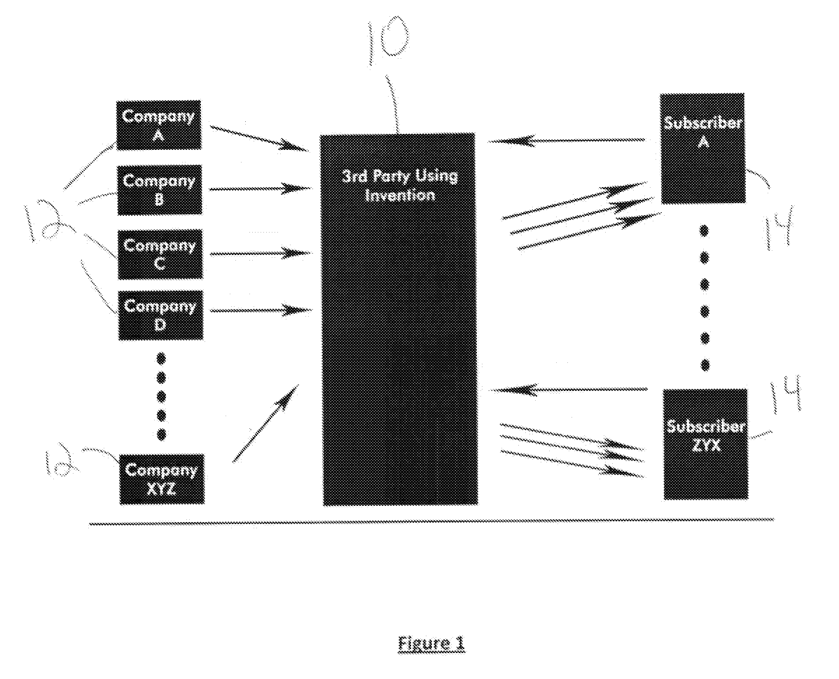

In one embodiment of the present arrangement as shown in FIG. 1, a 3^{rd} party advertising system 10 is provided, coupled to on one side a plurality of companies/clients 12. In FIG. 1 “company A”-“company XYZ” simply refers to the fact that system 10 is arranged to be in communication with any number of clients 12. On the subscriber/customer side, system 10 is likewise connected to a plurality of subscribers 14, such as for example using internet connections (not shown).

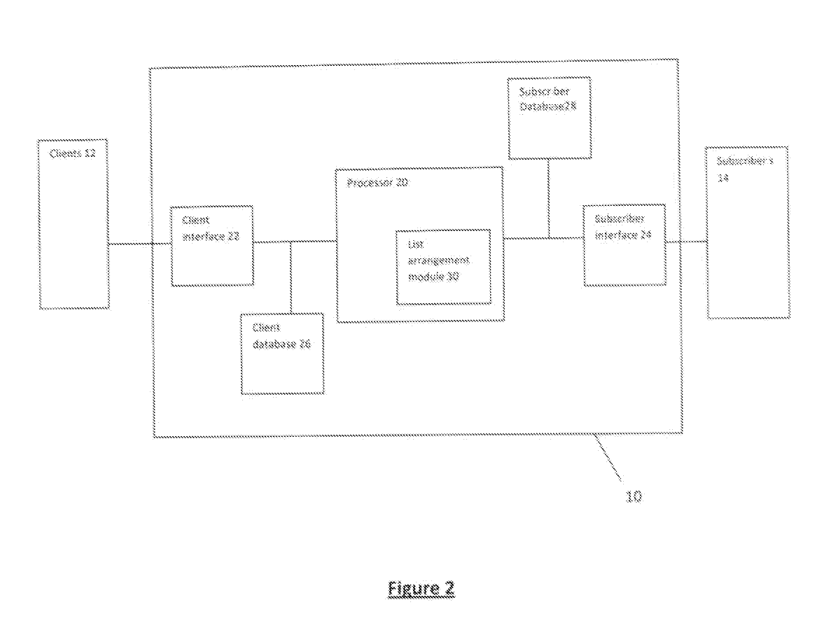

According to one embodiment, in FIG. 2, system 10 is shown with several exemplary components for supporting the various features of the invention. It is understood that such components are considered exemplary for illustration purposes and are not intended to be limiting. For example, certain system features and operations may be combined or separated into more or fewer components depending on system requirements, geographic locations of servers etc. . . . .

In FIG. 2, system 10 employs a processer 20 that is primarily for managing the various operations of system 10, including but not limited to interface operations with clients 12 and subscribers 14, database management, subscriber attribute/profile management, client advertisement options/management, billing etc. . . . . A client interface 22 is provided for allowing back and forth communications between system 10 and clients 12. Likewise, subscriber interface 24 is provided for allowing back and forth communications between system 10 and subscribers 14.

Additionally, system 10 has a client database 26. Client database 26 is one or more databases for containing all of the data required for system-client relationships, and advertisement functions, including but not limited to storage of advertisements for delivery to subscribers, storage of delivery instructions for what is to be sent and to who (described in detail below), client 12 billing and management information etc. . . . .

A subscriber database 28 similarly containing all of the data required for system-subscriber relationships, and advertisement functions, including but not limited to storage of basic address and contact profile information of the subscribers, as well as attribute and event information for receiving pushed advertising (described in detail below), as well as any data required to collect payment from clients 12 generated from completed purchases and/or clicks and/or views and/or other actions by subscribers 14 as described in more detail below.

System 10, as part of or connected to processor 20 may include a list/arrangement module 30 that compiles the various profile/attribute/event data options available to subscribers 14 so that clients 12, contact system 10 via interface 22 and may conveniently select the profiles and attribute qualities of the various subscribers 14 that the they would like for their advertisements to be delivered to. Such list module 30 is coupled with processor 20 and both client and subscriber databases 24 and 26 to store such selected options and make the necessary advertisement deliveries to subscribers 14 based on the related data in subscriber database 26.

It is understood that the above described components are simply exemplary components and modules for supporting the various features of the present system. Additional modules and functions may be supported by system 10 as appropriate to handle all functionality described above in the summary portion and below in the descriptions of the various steps managed by system 10.

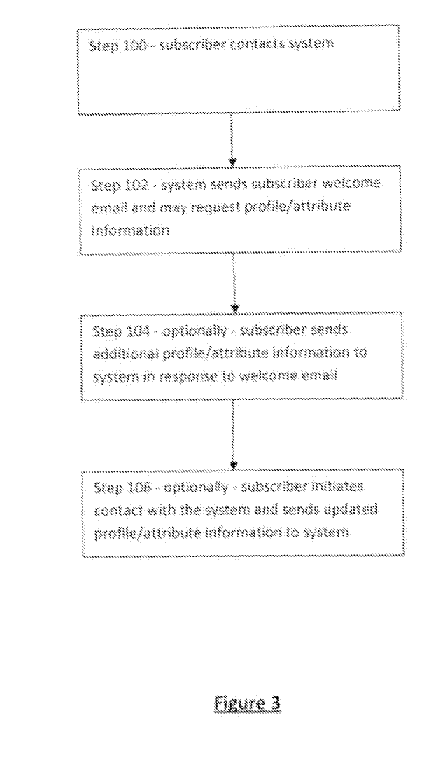

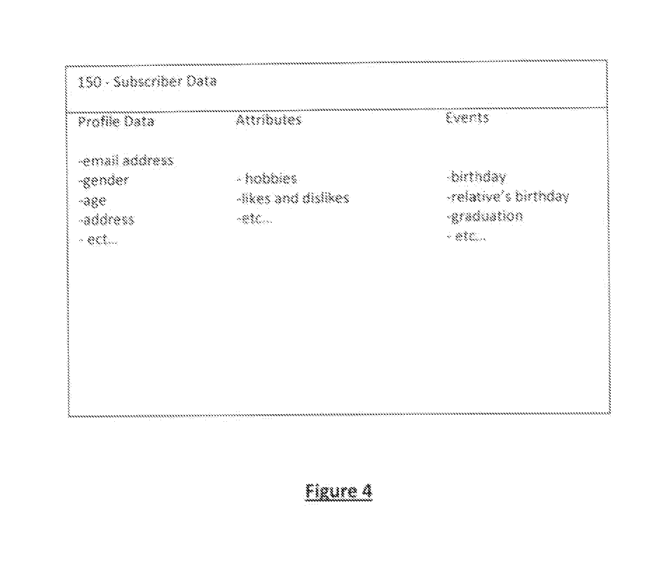

Turning to subscriber 14 opting-in to system 10, FIG. 3 is a flow chart showing an opt-in arrangement. At a first step 100, a subscriber 14 contacts system 10 and registers with the system by providing personal information described in more detail below. This information may include but is not limited to current email address, zip code, gender, and birthday and other event information. At step 102 a welcome email is sent to the subscriber. The step 102 welcome email acknowledges successful sign up for the system and may request additional profile/attribute information from subscribers 14. Although there is no requirement, nor is there necessarily any request to provide additional information, if the subscriber responds to that request, at step 104, subscriber 14 provides additional profile information to system 10 for storage at subscriber database 26. Again, although there is no requirement, nor is there necessarily any request to provide additional information, possibly at step 106, a subscriber 14 may re-contact the system with updates. FIG. 4 shows an exemplary subscriber entry 150 for a subscriber with such data. It is understood that system 10 may maintain one or more subscriber entries 150 for each subscriber 14 to system 10.

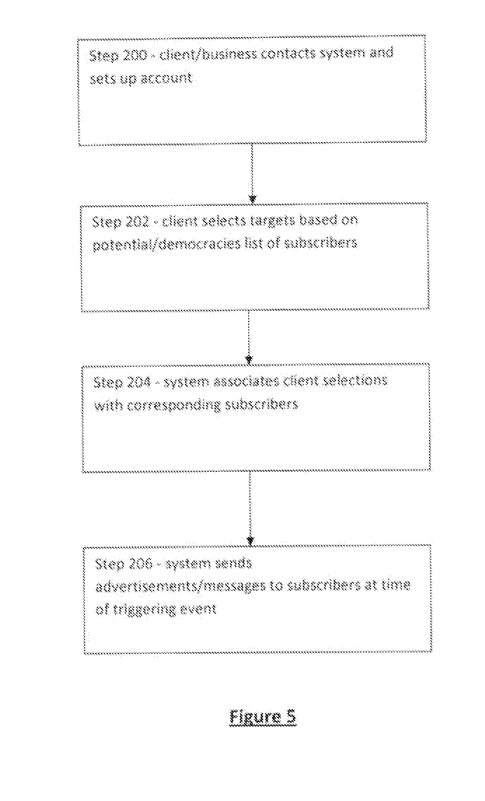

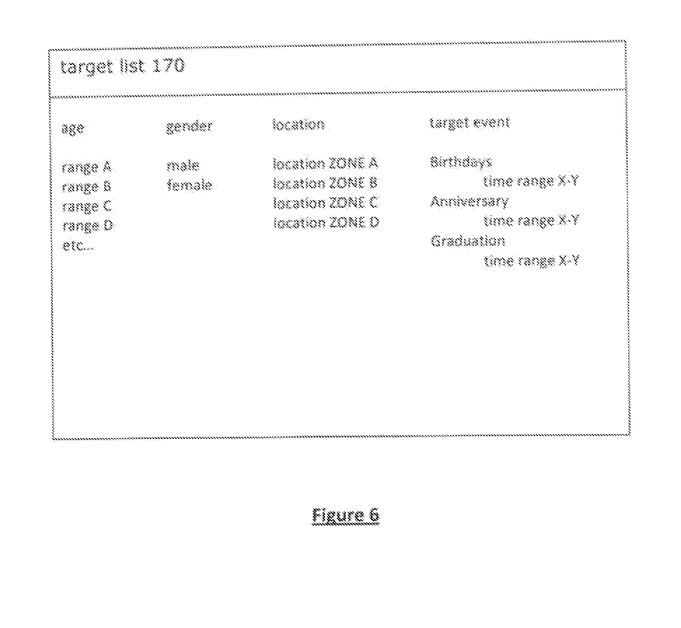

Turning to the client/businesses 12, a client 12 contacts system 10 and provides the various information required for arranging a business/billing account with the system through either a live representative or an interface screen. Once an account is opened, system 10 provides a manner for setting up a first advertisement for delivery to subscribers 14. As shown in flow chart FIG. 5, at step 200, client 12 contacts the system, opens the account and either arranges or delivers an advertisement for storage in client database 24. Next at step 202, system 10 provides a list from list module 30 showing the various demographics, subscriber attributes and events that the advertisement/coupon can be sent to. See for example exemplary FIG. 6 showing an interface screen including a target list 170 supported by list module 30 allowing client 12 to select who to send the advertisement to. For example, client 12 may direct an advertisement to females in zip codes XXXXX, age 30-35 having birthday between June 1^{st} and July 1^{st} Obviously, the options are too numerous to give all examples, but it is understood that some form of demographic targeting is selected and stored with client database 24.

Returning to FIG. 5, once client 12 makes the selection, system 10 then stores the advertisement and demographic attribute selections and, at step 204 associates the advertisement with the appropriate subscribers 14 in subscriber database 14 (i.e. the subscribers that meet the criteria selected by client 12). Thereafter, at step 206, system 10 delivers the advertisements to the correct recipient subscribers 14 at the time proscribed by client 12.

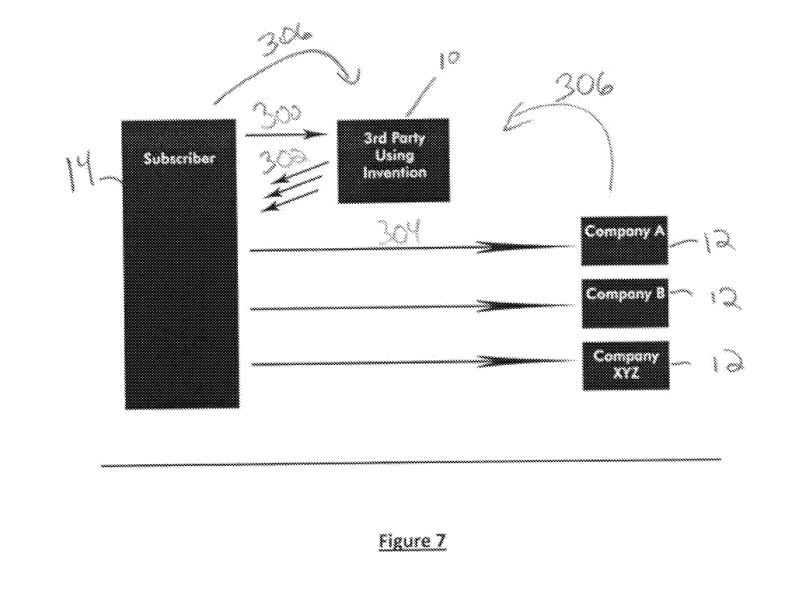

Turning to FIG. 7, a hybrid flowchart and system diagram shows the redemption by subscriber 14 of the advertisement. At step 300, reiterating certain steps from above, subscriber 14, provide attributes and profile information to system 10. At step 302, the system, employing the various stored advertising parameters arranged by clients 12, sends the appropriate advertisement(s) to subscribers 14 (e.g. by e-mail, text, etc. . . . ) At step 304, subscriber 14 can choose to interact via the advertisement/coupon, directly with the client/business 12. A final step 306 illustrates the various tracking communications that may be sent from either or both of subscribers 14 and clients 12 to system 10 for tracking of the delivery and opening of the advertisement.

It is understood that the above described components and steps are considered exemplary basic steps to implement the present arrangement and is not intended to be a full feature analysis of all possible features of the invention. Any of the features described in the summary and/or present description not explicitly included in the above system and flow diagrams may obviously be inserted into the above structure where appropriate.

Keeping with the above descriptions, the following is a brief description of certain examples implemented by such a system.

A subscriber 14 may opt-in to system 10 for inclusion on the list 150 of list module 30. By virtue of being included, or as an added benefit of being on list 170, the subscriber receives gifts (certificates for a free item, dollar off coupons, percentage off coupons, etc.) on a specific date or number of dates from system 10 on behalf of clients 12. The recipient subscriber 14 can then redeem these gifts at the third party companies as per FIG. 7.

### Example 1

### The Birthday Attribute

Subscribers 14 provide an e-mail address and/or instant messaging account and/or cell phone number, and/or social media information, etc. as well as their birth month (and possibly other information as well) to system 10. In celebration of that subscriber's birthday, system 10 emails and/or text messages and/or instant messages and/or messages through social media subscriber 14 special gifts (certificates for a free item, dollar off coupons, a percentage off coupons, etc.) on behalf of third party clients 12 based on the instructions provided by those clients 12. The subscriber 12 can then choose to redeem each gift directly with that client 12 or not.

It is noted that functionally, email deployment by system 10 may be managed through an email service provider. Emails may be automatically sent to subscribers 14 based on their unique birthday attribute and the specific client 12 for whom system 10 is sending the birthday gift. For example, on the first of the birthday month, the appropriate subscriber 14 receives birthday gifts from local restaurants. The date of email deployment may vary based on client 12 preference and industry (for example, a travel company's birthday campaign may be deployed farther in advance of the subscriber's birthday than the birthday campaign of a restaurant).

### Example 2

### The Anniversary Attribute

Subscriber 14 may provide an e-mail address and/or instant messaging account and/or cell phone number, and/or social media information, etc. as well as their anniversary month (and possibly other information as well). In celebration of that subscriber's anniversary, system 10 emails and/or text messages and/or instant messages and/or messages through social media the subscriber special gifts (certificates for a free item, dollar off coupons, a percentage off coupons, etc.) on behalf of third party clients 12 based on their instructions. Subscriber 14 can then choose to redeem each gift with the third party client 12.

### Example 3

### A Spouse's or Significant Other's Birthday

Subscriber 14 may provide an e-mail address, instant messaging account, cell phone number, and social media information, etc. as well as their significant other's birth month (and possibly other information as well). In celebration of that subscriber's 14 significant other's birthday, system 10 emails and/or text messages and/or instant messages and/or messages through social media the subscriber special gifts (certificates for a free item, dollar off coupons, a percentage off coupons, etc.) on behalf of third party clients 12. Subscriber 14 (or the significant other) can then choose to redeem each gift with the third party client 12, possibly creating a new account for the significant other.

Other examples of events in the profile of a subscriber 14 could include a half-birthday, a child's birthday, a pet's birthday, a celebrated holiday, a specific event that the subscriber may be interested in, etc. In each example, subscribers 14 provide an e-mail address, and/or instant messaging account, and/or cell phone number, etc. and some additional information. In celebration of something, or according to the demographics, system 10 owner emails and/or text messages and/or instant messages and/or messages through social media the subscriber special gifts (certificates for a free item, dollar off coupons, a percentage off coupons, etc.) on behalf of third party clients if that subscriber 14 meets the criteria as selected from the criteria list 170 described above.

After deployment of the advertisements/birthday gifts etc. . . . to subscribers 14, system 10 may provide clients 12 with a report of metrics including information such as the total number of recipients/subscribers 14 (that met the criteria as set forth on the selection list 170 as defined by the client), the number of subscribers 14 who opened the email/message, the number of recipients who clicked on the email/message, etc. . . . .

After deployment of the advertisements/gifts to subscribers 14, system 10 further may be configured to charge each client 12 based on at least one of the following methods:

A. CPM Rate—a fee based on the number of emails sent on behalf of client 12;
B. CPC Rate—a fee based on the number of clicks on any links related to client 12;
C. CPO Rate—a fee based on the number of opens of client's 12 advertisement/birthday gift email;
D. CPA Rate—a fee based on the number of subscribers 14 acquired by client 12 as a result of the advertisement/birthday email; and/or
E. Revenue Share—a fee based on the amount of revenue generated by client 12 as a result of the advertisement/birthday email.

System 10 may also charge different pricing based on the number of attributes the client uses in selecting subscribers 14 which receive the client's 12 advertisement/gift.

The same email service provider that potentially sends the advertisements/gifts to subscriber 14 may also accrue data on the birthday campaigns, such as open rate and click through rates, which links are clicked on, and other pertinent information for storage in the relevant databases 24 and 26.

It is noted that the advertisements/gifts emails etc. . . . are designed either by system 10 (based on information provided by client 12) or by client 12 directly. Typically, the advertisement images and text are placed between system 10 branding at the top and bottom of the email (in email marketing terms, placed in a system 10 wrapper). In addition to simply providing stock advertisement messages to the subscribers 14, system 10 may hybridize or customize the appearance of the individual advertisement messages for each individual.

For example, if a client 12, in May, when reviewing list 170 selects to have a particular birthday/advertisement sent to all females in zip codes XXXXX, age 30-35 having birthday between June 1^{st} and July 1^{st}, then system 10 may be configured to deliver the advertisements to the subscribers 14 in subscriber database 26 that meet such criteria on May 15th. However, client 12 may simply have provided a text for the advertisement/coupon/gift message that says “Happy Birthday! Enjoy 40% one pair of shoes if you come to the store on your birthday.” System 10 may then use additional subscriber profile information from tables 150 in subscriber database 26 to customize each individual advertisement to each subscriber. For example, the base message for a subscriber 14 “A” (32 year old named Julie with a birthday on June 18th) may be changed to read “Happy Birthday Julie! Enjoy 40% one pair of shoes if you come to the store on June 18^{th}.” Without having to further customize each message, client 12 can draft a base message with system 10, utilizing its stored subscriber 14 data, altering each message/advertisement accordingly for more a personalized feel. Other such customizations may be done using any stored subscriber 14 data in subscriber database 26. A similar personalization feature is to put a unique barcode or gift code or other unique identifier within the email to make redemption tracking clearer.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A system for collecting and distributing advertisements to customers based on an event or attribute of the customers, said system comprising:
a client interface, for receiving communications from a plurality of clients, said communications including at least one advertising content;
a client database, said client database configured to store said advertising content;
a processor coupled to said client interface and said client database, wherein said processor is configured to receive distribution parameters from said client, regarding the distribution of advertisement data to any one of a plurality of subscribers, said distribution parameters storable in said client database;
a subscriber interface, coupled to said processor configured to receive communications from a plurality of said subscribers desiring access to one or more client advertising content; and
a subscriber database connected to said processor and said subscriber interface which stores profile data for each of said subscribers, said profile data including at least one dated attribute associated with said subscriber,
wherein for each of said client advertisement content stored in said client database, a corresponding distribution attribute is stored including at least in part a distribution date, and
wherein said processor is configured to review a present date and compare against shared distribution dates and to distribute said advertisement content having said present date as a distribution date to one or more subscribers according to said distribution parameters.

2. The system as claimed in claim 1, wherein said profile data for each of said subscribers includes a combination of personal/demographic information in addition to said at least one dated attribute.

3. The system as claimed in claim 2, wherein said demographic information includes any one of an email address, home address/zip code, gender, age hobbies, likes and dislikes.

4. The system as claimed in claim 3, wherein said profile data for each of said subscribers includes multiple data attributes.

5. The system as claimed in claim 4, wherein said data attributes are selected from the group consisting of birthdays, relatives' birthdays, anniversaries, holidays and graduations dates.

6. The system as claimed in claim 1, wherein said distribution parameters from said client regarding the distribution of advertisement data, include both a distribution date as well as demographic parameters.

7. The system as claimed in claim 6, further comprising a list module compiling the various available dated attributes and demographic data of all of said subscribers stored in said profile data in said subscriber database.

8. The system as claimed in claim 1 wherein said client database contains billing data for billing said client for the distribution of said advertisement content.
